(19) United States
(12) Patent Application Publication
(10) Pub. No.: US 2018/0326974 A1
(43) Pub. Date: Nov. 15, 2018

(54) FUEL VAPOR PURGE CONTROL SYSTEM AND METHOD FOR HYBRID VEHICLE

(71) Applicants: Hyundai Motor Company, Seoul (KR); Kia Motors Corporation, Seoul (KR)

(72) Inventor: Hyun KIM, Hwaseong-si (KR)

(73) Assignees: Hyundai Motor Company, Seoul (KR); Kia Motors Corporation, Seoul (KR)

(21) Appl. No.: 15/807,788

(22) Filed: Nov. 9, 2017

(30) Foreign Application Priority Data
May 10, 2017 (KR) 10-2017-0058299

(51) Int. Cl. B60W 20/50; F02M 25/08

(52) U.S. Cl. CPC B60W 20/50; B60W 2510/0638; F02M 2025/0845; F02M 25/0809

(57) ABSTRACT

A fuel evaporation gas purge control method for a hybrid vehicle may include collecting an evaporation gas generated in a fuel tank to a canister; controlling a purge control solenoid valve to provide the evaporation gas collected in the canister to a combustion chamber; monitoring a fault of the purge control solenoid valve; and controlling a torque of an engine by use of a hybrid starter-generator (HSG) when the fault of the purge control solenoid valve is detected.

### CROSS-REFERENCE TO RELATED APPLICATION

The present application claims priority to Korean Patent Application No. 10-2017-0058299 filed on May 10, 2017, the entire contents of which is incorporated herein for all purposes by the present reference.

### BACKGROUND OF THE INVENTION

### Field of the Invention

The present invention relates to a fuel vapor purge control system for a hybrid vehicle and a control method thereof.

### Description of Related Art

The automotive industry has actively sought to reduce pollutants in exhaust gases. One method for reducing pollutants in exhaust gases is by use of canister purge.

Here, the canister includes an absorbent material including activated carbon for absorbing the fuel vapor or fuel evaporation gas from the fuel tank or a float chamber and for preventing discharge of the fuel vapor or fuel evaporation gas to the atmosphere.

Like this, the absorbed fuel vapor can be transmitted to an engine for combustion through a pressure control solenoid valve (Purge Control Solenoid Valve; PCSV) which is controlled by an engine control unit (ECU).

On the other hand, in a hybrid vehicle, an engine for generating power by combusting a fuel and a motor configured for outputting power of a battery are together provided.

However, when the purge control solenoid valve is completely opened by a fault occurrence of the purge control solenoid valve, the abnormal evaporation gas excessively inflows to the combustion chamber, there is a problem that an engine starting off is generated.

To prevent this, a RPM of the engine may increase through the control of an air amount, an ignition timing, or a fuel amount, the like, however there is a difficulty that a torque increasing by the combust of an internal combustion engine causes a physical time delay.

The information disclosed in this Background of the Invention section is only for enhancement of understanding of the general background of the invention and may not be taken as an acknowledgement or any form of suggestion that this information forms the related art already known to a person skilled in the art.

### BRIEF SUMMARY

Various aspects of the present invention are directed to providing a fuel vapor purge control system for a hybrid vehicle preventing the starting off of the engine by increasing the engine RPM upon the fault of the purge control solenoid valve in the hybrid vehicle and a control method thereof.

A fuel evaporation gas purge control method for a hybrid vehicle according to an exemplary embodiment of the present invention includes collecting an evaporation gas generated in a fuel tank to a canister; controlling a purge control solenoid valve to provide the evaporation gas collected in the canister to a combustion chamber; monitoring a fault of the purge control solenoid valve; and controlling a torque of an engine by use of a hybrid starter-generator (HSG) when the fault of the purge control solenoid valve is detected.

The step monitoring the fault may include determining that the fault is generated when a ground short of the purge control solenoid valve is generated, and determining that the purge control solenoid valve is opened such that the evaporation gas inflows to the combustion chamber.

The step controlling the torque of the engine may include compensating the torque of the engine through a torque control of the starter-generator.

The step compensating the engine torque may further include increasing an RPM of the engine till a target value through the torque control of the starter-generator.

The step controlling the torque of the engine may further include stopping the torque control of the starter-generator when the RPM of the engine reaches the target value.

A fuel vapor purge control system for a hybrid vehicle according to an exemplary embodiment of the present invention includes a canister collecting an evaporation gas generated in a fuel tank; a purge control solenoid valve connected to the canister to provide the evaporation gas collected in the canister to the combustion chamber; and a control apparatus monitoring a fault of the purge control solenoid valve and controlling a torque of an engine through a torque control of a hybrid starter-generator (HSG) to be compensated.

The control apparatus may include a fault monitoring device monitoring the fault of the purge control solenoid valve; and a torque control device controlling the torque of the engine to be compensated by controlling the torque of the starter-generator when the fault of the purge control solenoid valve is detected.

The fault monitoring device may determine that the purge control solenoid valve is opened such that the evaporation gas inflows to the combustion chamber when a ground short of the purge control solenoid valve is generated.

The torque control device may increase the RPM of the engine till a target value though the torque control of the starter-generator and stops the torque control of the starter-generator when the RPM of the engine reaches the target value.

The starter-generator may include a mild hybrid starter-generator (MHSG).

According to an exemplary embodiment of the present invention, when the fault is generated in the purge control solenoid valve purging the evaporation gas collected in the canister to the combustion chamber, as the RPM of the engine immediately increases through the torque control of the starter-generator, the starting off of the engine due to the exceed inflow of the evaporation gas may be prevented and an environment improving a responsiveness and a stability of the hybrid vehicle may be provided.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram schematically showing a hybrid vehicle including a fuel vapor purge control system for a hybrid vehicle according to an exemplary embodiment of the present invention.

FIG. 2 is a schematic view showing a fuel vapor purge control system for a hybrid vehicle according to an exemplary embodiment of the present invention.

FIG. 3 is a schematic view showing a connection structure of a purge control solenoid valve according to an exemplary embodiment of the present invention.

FIG. 4 is a flowchart schematically showing a process controlling a torque of an engine by monitoring of a fault of a purge control solenoid valve according to an exemplary embodiment of the present invention.

FIG. 5 is a graph showing an exemplary embodiment that an engine starting off is generated upon a purge control solenoid valve fault according to a related art.

FIG. 6 is a graph showing an exemplary embodiment preventing an engine starting off upon a purge control solenoid valve fault according to an exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In addition, unless explicitly described to the contrary, the word “comprise” and variations such as “comprises” or “comprising”, will be understood to imply the inclusion of stated elements but not the exclusion of any other elements.

The parts indicated by the same reference numerals are the same components throughout the specification.

It is understood that the term “vehicle” or “vehicular” or other similar term as used herein is inclusive of motor vehicles in general including passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, and other alternative fuel vehicles (e.g., fuels derived from resources other than petroleum).

Additionally, it is understood that the exemplary processes may be performed by one or plurality of controllers. It is understood that the term controller/control device refers to a hardware device that includes a memory and a processor. The memory is configured to store the modules, and the processor is specifically configured to execute the modules to perform one or more processes which are described further below.

Furthermore, control logic of the present invention may be embodied as non-transitory computer readable media on a computer readable medium including executable program instructions executed by a processor, controller/control device, or the like. Exemplary embodiments of the computer readable mediums include, but are not limited to, ROM, RAM, compact disc (CD)-ROMs, magnetic tapes, floppy disks, flash drives, smart cards, and optical data storage devices. The computer readable recording medium can also be distributed in network coupled computer systems so that the computer readable media is stored and executed in a distributed fashion, e.g., by a telematics server or a Controller Area Network (CAN).

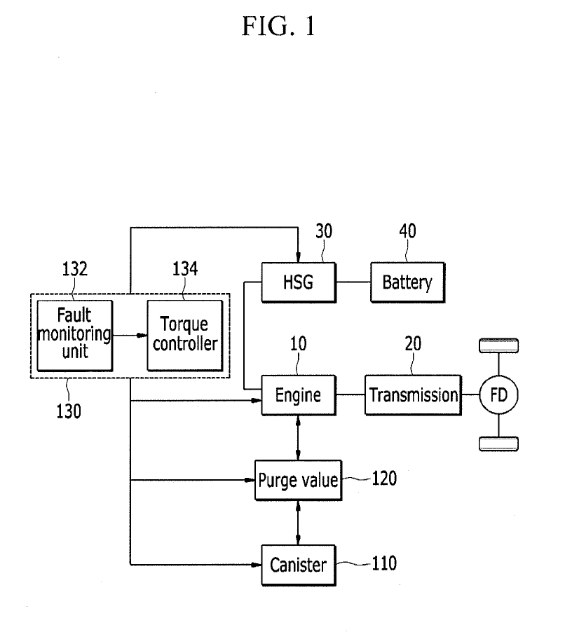

Now, a fuel vapor purge control system for a hybrid vehicle and a control method thereof according to an exemplary embodiment of the present invention will be described with reference to FIG. 1 to FIG. 6.

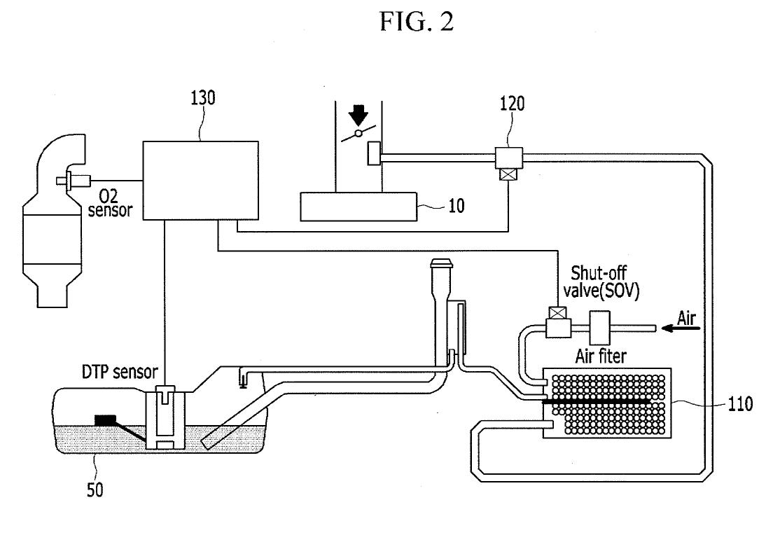

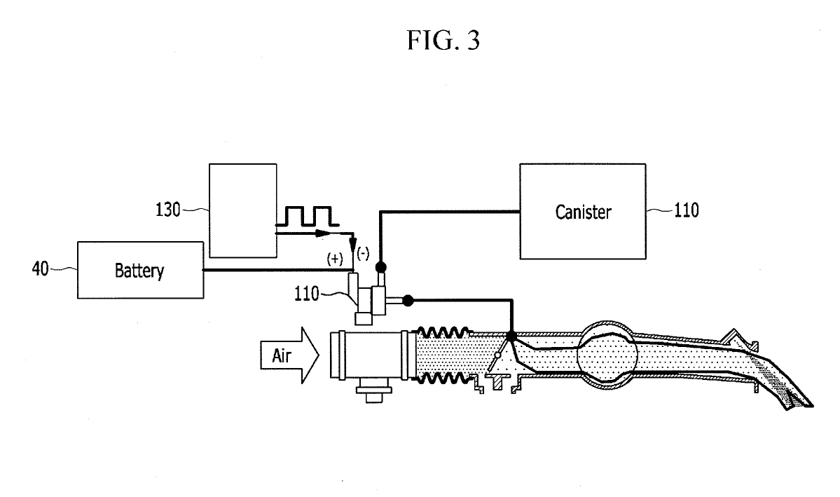

FIG. 1 is a block diagram schematically showing a hybrid vehicle including a fuel vapor purge control system for a hybrid vehicle according to an exemplary embodiment of the present invention, FIG. 2 is a schematic view showing a fuel vapor purge control system for a hybrid vehicle according to an exemplary embodiment of the present invention, and FIG. 3 is a schematic view showing a connection structure of a purge control solenoid valve according to an exemplary embodiment of the present invention. In the instant case, the fuel vapor purge control system for a hybrid vehicle according to an exemplary embodiment of the present invention only shows a schematic configuration required to explain an exemplary embodiment of the present invention and it is not limited thereto.

As shown in FIG. 1, the hybrid vehicle according to an exemplary embodiment of the present invention includes an engine 10, a transmission 20, a hybrid starter-generator (HSG) 30, a battery 40, a canister 110, a purge control solenoid valve (PCSV) 120, and a control apparatus 130. Here, the hybrid vehicle includes a mild hybrid vehicle according to an exemplary embodiment of the present invention. Also, the hybrid starter-generator includes a mild hybrid starter-generator (MHSG) according to an exemplary embodiment of the present invention.

The engine 10 as a power source outputs a power in a starting on state.

The transmission 20 may be applied with one of an automatic transmission (AMT) or a dual clutch transmission (DCT), and selects any shift gear according to a vehicle speed and a driving condition to output a driving force to a driving wheel, maintaining a driving.

The HSG 30 is connected to the engine 10 through a belt. Also, the HSG 30 is connected to accessory elements of the engine 10 to receive a drive power source through an internal inverter, starting the engine 10 or assisting the output of the engine 10. Also, the HSG 30 is operated as a generator in coast down driving to supply regeneration energy to the battery 40.

The battery 40 is electrically connected to the HSG 30 to store a voltage to drive the HSG 30. When the battery 40 assists the output of the engine 10, the battery 40 supplies the driving voltage to the HSG 30 and is changed with the voltage generated in the HSG 30 during a regenerative braking. In an exemplary embodiment of the present invention, the battery 40 may be a 48V battery.

The canister 110 collects an evaporation gas generated from the fuel tank 50.

The purge control solenoid valve 120 provides the evaporation gas collected in the canister 110 to a combustion chamber of the engine 10 by the control of the control apparatus 130.

The control apparatus 130 controls an opening/closing operation of the purge control solenoid valve 120 and monitors the fault of the purge control solenoid valve 120.

Referring to FIG. 2 and FIG. 3, the purge control solenoid valve 120 includes a positive terminal (+) connected to the battery 40 and a negative terminal (−) connected to the control apparatus 130.

The control apparatus 130 executes an ON/OFF control of the valve through the negative terminal (−) of the purge control solenoid valve 120. Also, the control apparatus 130 controls an open amount of the purge control solenoid valve 120 through a PWM DUTY control to control an amount of the evaporation gas inflowing to the combustion chamber.

However, when a ground short is generated in the negative terminal (−) of the purge control solenoid valve 120, the power of the battery 40 is constantly supplied to the positive terminal (+) of the purge control solenoid valve 120.

Further, when the power is supplied to the positive terminal (+) of the purge control solenoid valve 120, the purge control solenoid valve 120 is opened by 100%, the evaporation gas collected to the canister 110 inflows to the combustion chamber of the engine 10 regardless the control of the control apparatus 130. Accordingly, a starting off problem of the engine may be generated depending on the excessive inflow of the abnormal evaporation gas when the ground short of the purge control solenoid valve 120 is generated.

Accordingly, when the fault of the purge control solenoid valve 120 is detected, the control apparatus 130 controls the torque of the engine 10 through the torque control of the HSG 30 to be compensated to prevent the starting off problem of the engine.

The control apparatus 130 includes a fault monitoring device 132 monitoring the fault of the purge control solenoid valve according to an exemplary embodiment of the present invention and a torque control device 134 controlling the engine torque to be compensated by controlling the torque of the starter-generator 30.

When the ground short is generated in the purge control solenoid valve 120, the fault monitoring device 132 determines that the purge control solenoid valve 120 is completely opened such that the evaporation gas inflows to the combustion chamber.

The torque control device 134 increases the RPM of the engine 10 till a target value through the torque control of the starter-generator 30. Further, when the RPM of the engine 10 reaches the target value, the torque control device 134 controls the torque control of the starter-generator 30 to be stopped.

For the present purpose, the control apparatus 130 may be implemented by at least one processor operated by a predetermined program, and the predetermined program may be programed to execute each step of a control method of the fuel evaporation gas purge for the hybrid vehicle according to an exemplary embodiment of the present invention.

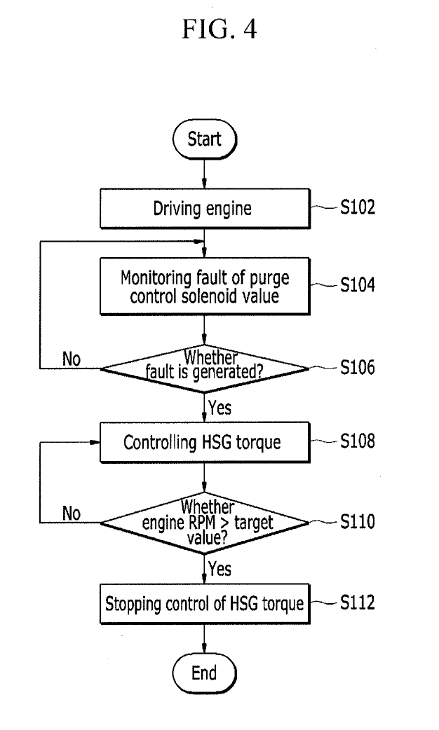

FIG. 4 is a flowchart schematically showing a process controlling a torque of an engine by monitoring of a fault of a purge control solenoid valve according to an exemplary embodiment of the present invention. The flowchart below is described by use of the same reference numerals in cooperation with the configurations of FIG. 1 to FIG. 3.

Referring to FIG. 4, the control apparatus 130 according to an exemplary embodiment of the present invention monitors the fault of the purge control solenoid valve 120 when driving the engine 10 (S102 and S104).

In the instant case, when it is determined that the fault is generated by the short occurrence in the negative terminal of the solenoid valve 120, the solenoid valve 120 is completely opened, and it may be determined that the evaporation gas collected in the canister 110 inflows to the combustion chamber of the engine 10 regardless of the control of the control apparatus 130.

Also, the control apparatus 130 according to an exemplary embodiment of the present invention controls the torque of the HSG 30 compensates the torque of the engine when the fault is generated in the purge control solenoid valve 120 (S106 and S108).

In the instant case, the control apparatus 130 according to an exemplary embodiment of the present invention increases the RPM of the engine through the torque control of the HSG 30 till the target value. Here, the HSG 30 may be the mild hybrid starter-generator (MHSG) according to an exemplary embodiment of the present invention.

Also, the control apparatus 130 according to an exemplary embodiment of the present invention finishes the torque control of the HSG 30 when the RPM of the engine exceeds the target value (S110 and S112).

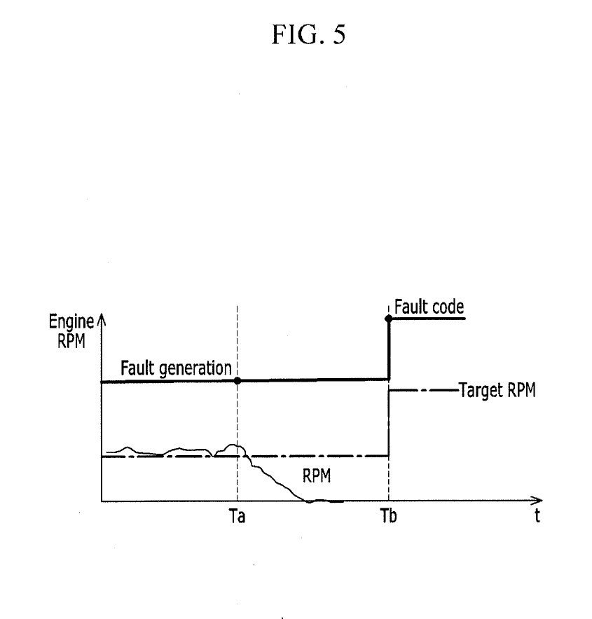

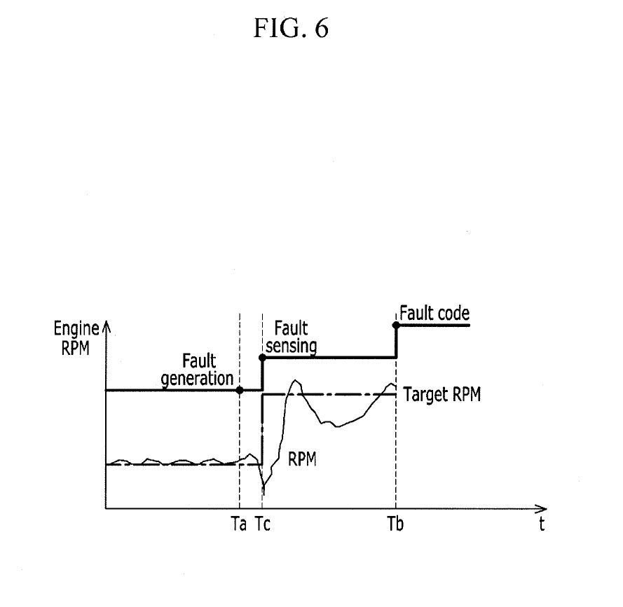

FIG. 5 is a graph showing an exemplary embodiment that an engine starting off is generated upon a purge control solenoid valve fault according to a related art, and FIG. 6 is a graph showing an exemplary embodiment preventing an engine starting off upon a purge control solenoid valve fault according to an exemplary embodiment of the present invention.

As shown in FIG. 5, when the fault is generated in the conventional purge control solenoid valve 120 (Ta), there is the problem that the engine starting off is generated before increasing the engine torque after the fault of the valve is confirmed (Tb). In conventional, the torque of the engine may increase by controlling the air amount, the ignition timing, or the fuel amount, the like, however the increasing of the torque by the combust of the internal combustion engine has the difficulty causing the physical time delay.

Accordingly, as shown in FIG. 6, the fuel vapor purge control system for the hybrid vehicle according to an exemplary embodiment of the present invention immediately compensates the torque of the engine 10 through the torque control of the starter-generator 30 when the fault of the purge control solenoid valve 120 is detected (Tc).

That is, the fuel vapor purge control system for the hybrid vehicle according to an exemplary embodiment of the present invention immediately increases the RPM of the engine when the purge control solenoid valve 120 fails, preventing the engine starting off.

As above-described, as the fuel vapor purge control system for the hybrid vehicle and the control method thereof according to an exemplary embodiment of the present invention immediately increases the RPM of the engine through the torque control of the starter-generator when the purge control solenoid valve purges the evaporation gas collected in the canister to the combustion chamber fails, the starting off of the engine due to the excessed inflow of the evaporation gas may be prevented, and an environment improving a responsiveness and a stability of the hybrid vehicle may be provided.

The foregoing exemplary embodiments of the present invention are not implemented only by an apparatus and a method, and therefore may be realized by programs realizing functions corresponding to the configuration of the exemplary embodiment of the present invention or recording media on which the programs are recorded. Such recording media may be executed in a user terminal as well as a server.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A control method of a fuel evaporation gas purge for a hybrid vehicle comprising:
collecting an evaporation gas generated in a fuel tank to a canister;
controlling a purge control solenoid valve to provide the evaporation gas collected in the canister to a combustion chamber;
monitoring a fault of the purge control solenoid valve; and
controlling a torque of an engine by use of a hybrid starter-generator (HSG) when the fault of the purge control solenoid valve is detected.

2. The control method of claim 1, wherein the step monitoring the fault includes:
determining that the fault is generated when a ground short of the purge control solenoid valve is generated; and
determining that the purge control solenoid valve is opened such that the evaporation gas inflows to the combustion chamber.

3. The control method of claim 1, wherein
the step controlling the torque of the engine includes
compensating the torque of the engine through a torque control of the hybrid starter-generator.

4. The control method of claim 3, wherein
the step compensating the engine torque further includes
increasing a Revolution Per Minute (RPM) of the engine to a target value through the torque control of the hybrid starter-generator.

5. The control method of claim 3, wherein
the step controlling the torque of the engine further includes
stopping the torque control of the hybrid starter-generator when the RPM of the engine reaches the target value.

6. A fuel vapor purge control system for a hybrid vehicle comprising:
a canister collecting an evaporation gas generated in a fuel tank;
a purge control solenoid valve connected to the canister to provide the evaporation gas collected in the canister to the combustion chamber; and
a control apparatus monitoring a fault of the purge control solenoid valve and controlling a torque of an engine through a torque control of a hybrid starter-generator (HSG) to be compensated.

7. The fuel vapor purge control system for the hybrid vehicle of claim 6, wherein
the control apparatus includes
a fault monitoring device monitoring the fault of the purge control solenoid valve; and
a torque control device controlling the torque of the engine to be compensated by controlling a torque of the starter-generator when the fault of the purge control solenoid valve is detected.

8. The fuel vapor purge control system for the hybrid vehicle of claim 7, wherein
the fault monitoring device determines that the purge control solenoid valve is opened such that the evaporation gas inflows to the combustion chamber when a ground short of the purge control solenoid valve is generated.

9. The fuel vapor purge control system for the hybrid vehicle of claim 7, wherein
the torque control device increases the RPM of the engine to a target value though the torque control of the starter-generator and stops the torque control of the starter-generator when the RPM of the engine reaches the target value.

10. The fuel vapor purge control system for the hybrid vehicle of claim 6, wherein
the starter-generator includes a mild hybrid starter-generator (MHSG).
